(19) United States
(12) Patent Application Publication
(10) Pub. No.: US 2010/0038007 A1
(43) Pub. Date: Feb. 18, 2010

(54) Method for making surface overlays, structures, and structural components

(76) Inventors: Don W. Sluder, Lake Jackson, TX (US); David L. Silva, Houston, TX (US)

Correspondence Address: John William Sparks, 3602 Burke Rd. #171, Pasadena, TX, 77504, US

(21) Appl. No.: 12/228,364

(22) Filed: Aug. 12, 2008

(51) Int. Cl. B27N 3/00

(52) U.S. Cl. 156/62.2

(57) ABSTRACT

Methods are disclosed for making surface overlays, structures, and structural components. The method comprises an optional step of preparing the surface, an optional step of making an exterior construction form, cutting grating materials to fit, making encapsulated panels from the grating materials, an optional step of making an interior construction form, disposing the encapsulated panels in the desired position, mixing aggregate blend, adding aggregate blend to the encapsulated panels or grating structure, an optional step of curing the aggregate blend, and optional finishing procedures.

### FIELD

This invention relates to making surface overlays, structures, and structural components.

### BACKGROUND

Construction, structural maintenance and structural repair are big business. Time and use degrades structures. Businesses are looking for better ways of making, maintaining, and repairing structures. Structures need to be built from cheap, durable, and strong materials. Structures need to be maintained by applying cheap, durable, and strong materials to surfaces to slow down the degradation process caused by time and use. Structures need to be repaired with cheap, durable, and strong materials.

There are many methods of making, maintaining, and repairing structures. These methods have problems. If the materials are cheap, then those materials are either weak or non-durable. If the materials are durable and strong, then those materials are expensive.

Metal, concrete, and wood are the main building materials. Metal is strong, but not very durable. Metal corrodes. Metal is chemically reactive. Concrete is strong, but it wears away with constant abrasive uses. Concrete is susceptible to impact damage. Concrete reacts with chemicals. Wood is strong. Wood is destroyed by termites, fire, water, and impact damage.

Currently, and in the past, many structures have been made from concrete, wood, and steel. These structures need replacement, maintenance, and repair.

The methods disclosed, herein, are a very good way of repairing concrete, steel, wood and other structures. Bonding agents are grout, epoxy, and resins. The methods use bonding agents and structural components embedded in the bonding agents to make, maintain, and repair structures. Grout is a cheap and durable material that is chemically resistant, water resistant, absorbs impacts, and is easy to apply. The structural components, embedded in the grout, create strong materials. These methods are a very good way to make, maintain, and repair structures.

### SUMMARY

Methods are disclosed for making surface overlays, structures, and structural components. The method comprises an optional step of preparing the surface, an optional step of making an exterior construction form, cutting grating materials to fit, making encapsulated panels from the grating materials, an optional step of making an interior construction form, disposing the encapsulated panels in the desired position, mixing aggregate blend, adding aggregate blend to the encapsulated panels or grating structure, an optional step of curing the aggregate blend, and optional finishing procedures. These methods create surfaces and structures that are resistant to corrosion, acids, and bases.

Surface preparation is the procedures used to prepare a pre-existing surface for applying the method or some variation of the method. A construction form is a structure, framework, or form that is commonly used in the construction industry to build structures. An exterior construction form is a construction form that partially or completely surrounds a space where a structure, structural component, or surface overlay is to be built.

The step of cutting grating materials consists of cutting grating materials to fit the particular project. The grating materials may be cut by a torch, a saw, bolt cutters, pliers, scissors, a cleaver, a splitter, a grinder, or a knife. Grating materials are singular structural reinforcement members. The encapsulated panel is a grating material that has been encapsulated in a bonding agent. The bonding agents are usually resin or grout.

The aggregate blend is a mixture of resins, grout, and fill materials. The bonding agent or aggregate blend may be applied or added by coating, dipping, dripping, pouring, spraying, or applying with a trowel. A grating structure is an assembled structure made of encapsulated panels, rods, bearing bars, grating materials, and any other structural members associated with the encapsulated panels, rods, bearing bars, or grating materials.

The order of performing the method steps can vary. Those skilled in the art can make appropriate choices about the order of doing the steps of the method.

These and other features, aspects, and advantages of the present invention will become better understood with regard to the following description, appended claims, and accompanying drawings.

### BRIEF DESCRIPTION OF THE DRAWINGS

FIG. 1 depicts a flow diagram of a version of the method,

FIG. 2 depicts a flow diagram of a version of the method, and

FIG. 3 depicts a flow diagram of a version of the method.

### DESCRIPTION

Methods are disclosed for making surface overlays, structures, and structural components. The method comprises an optional step of preparing the surface, an optional step of making an exterior construction form, cutting grating materials to fit, making encapsulated panels from the grating materials, an optional step of making an interior construction form, disposing the encapsulated panels in the desired position, mixing aggregate blend, adding aggregate blend to the encapsulated panels or grating structure, an optional step of curing the aggregate blend, and optional finishing procedures. The order of these steps may vary depending upon whether the prior structure is damaged, a new structure is being made, or a form or enclosure previously exists. Those skilled in the art will appreciate the many different variations and modifications that can be employed in applying the method.

The term “grout” refers to an epoxy grout, a latex grout, a vinyl ester grout, a polyester grout, a cement grout, a resin grout, or any other grout. The phrase “aggregate filled materials” or “aggregate fill material” is any aggregate or fill material. The phrases “aggregate filled materials” and “aggregate fill materials” expressly includes concrete, sand, polymers, cement, rock, colloidal substances, additives, rubber, and plant fibers.

A “bonding agent” is any adhesive, resin, epoxy, grout, or any mixture of these with aggregate fill materials. The term “aggregate blend” is any resin, epoxy, grout, bonding agent, any mixture thereof, or any mixture of these with aggregate fill materials. The term “encapsulated” expressly includes encased, coated, or dipped. An “encapsulated panel” is a grating material that has been encapsulated in a bonding agent. The bonding agent or aggregate blend may be applied or added by coating, dipping, dripping, pouring, spraying, or applying with a trowel.

“Surface preparation” is the procedures used to prepare a pre-existing surface for applying the method or some variation of the method. The phrase “preparing the surface” expressly includes surface preparation procedures. The phrases “preparing the surface” and “surface preparation” are used synonymously.

A “construction form” is a structure, framework, or form that is commonly used in the construction industry to build structures. The term “construction form” expressly includes an assemblage of structural members, segmented structural members, grating materials, bearing bars, or rods. An “exterior construction form” is a construction form that partially or completely surrounds a space where a structure, structural component, or surface overlay is to be built. An “interior construction form” is a structure or framework that is built to occupy and be disposed within a structure, structural component, or surface overlay that is to be built.

A “grating material” is a singular structural reinforcement member. The term “grating material” expressly includes gratings, reversible gratings, metal gratings, gratings with cutouts, pultruded fiberglass gratings, molded gratings, expanded metal gratings, carbon fiber fabric, carbon fiber mesh, wire mesh, plastic mesh, and fiberglass gratings.

“Finishing procedures” are any steps that occur after the step of adding the aggregate blend. “Finishing procedures expressly includes troweling the surface of the structure, compression molding, painting, removing exterior construction forms, removing excess materials, or any other steps to make the structure or surface suitable for the customer's needs or desires.

“Bearing bars” are structural support members. “Bearing bars” are members extending in the direction of the grating span or the span of the encapsulated panels. Bearing bars are disposed to support the grating or encapsulated panels. Some grating materials have bearing bars. Bearing bars can be part of the grating material or the bearing bars can be added to the grating material for support.

“Rods” are structural support members. “Rods” are the connecting rods or bars which extend orthogonally across the bearing bars. The term “rods” expressly includes cross rods and cross bars. The rods intersect the bearing bars. The rods are welded, forged, tied, clamped, fastened, or mechanically locked to the bearing bars.

The term “sealant” is any ingredient or mixture of ingredients for sealing adjacent components. The term “sealant” expressly includes putty, silicone, urethane, butyl rubber, rubber, gasket material, adhesives, and polysulfide.

The term “structural members” are any members for supporting or holding one or more elements, segments, or parts together. The term “structural members” expressly includes bolts, all thread, pipes, bars, rebar, beams, cable, rope, and nylon straps. The structural members can be made of metal, fiberglass, plant fibers, or polymers. A “grating structure” is an assembled structure made of encapsulated panels, rods, bearing bars, grating materials, and any other structural members associated with the encapsulated panels, rods, bearing bars, or grating materials. The term “construction form” expressly includes grating structures. The term “elongated structural members” is any structural member that is long and slender.

The fastening means for the structural members includes welding, bolts and nuts, buckles, knots, screws, forging, clamps, pins and orifices, wire tie, plastic tie, and adhesives. The structural members can be stretched prior to being affixed with fastening means. The term “fasten” or “fastened” is to fasten by any fastening means.

The surface preparation can take many forms. Sand blasting, chipping away the surface, application of high pressure air or water to remove debris, sanding, removing loose surfaces, sweeping, and shoveling are some of the ways of preparing the surface. In many cases, surface preparation may be minimal or not needed.

An exterior construction form can be made for making new structures or repairing existing structures. A construction form can be made for embedding inside the structure being made. Panels can be employed to make the construction forms. Panels with orifices can be used to make construction forms. Members can be incorporated into the making of construction forms. Rods can make construction forms. Panels and rods can be used to make construction forms of either the exterior or embedded variety of construction forms. The rods can occupy the orifices of the panels to make construction forms.

Metal gratings, carbon fiber fabric, carbon fiber mesh, pultruded fiberglass, fiberglass gratings can be structural components in the invention methods and in the construction form. Other structural components can be expanded metal, wire mesh, and plastic mesh, fiberglass rebar, epoxy coated rebar, bearing bars, cross bars, rods, and metal rebar. These structural components give the structures being made strength. The rebar structural components can be used as rods. The bearing bars are vertically disposed members. The bearing bars are structural components for bearing any weight being applied to the structure.

The encapsulated panels can be made from the structural components by applying resins, epoxy, and grout to encapsulate the structural components. The metal gratings, carbon fiber fabric, carbon fiber mesh, pultruded fiberglass, fiberglass gratings, expanded metal, wire mesh, and plastic mesh can be used to make the encapsulated panels. When making encapsulated panels, structural components of one-fourth to 2 inch thickness are preferred. After encapsulation, the panels are one-fourth of an inch thick or greater. The resins commonly used are isophthalic-polyester, vinyl ester, bis-phenol A epoxy, high temperature, and bis-phenol F epoxy resin. Epoxy and grout can be used to make panels. By varying the mixture of resin, epoxy, and grout panels can be produced with different compressive, tensile, and sheer physical properties.

The step of preparing the surface is generally not required. The bonding agents being used in this method are very good at adhering to surfaces. Surface preparation is usually performed when the space or surface has debris, soil to be removed, or has obstructing matter that would hinder the bonding of the bonding agents.

The step of making construction forms may occur early or near the middle of the method. The construction forms for a project may be an interior construction form, an exterior construction form, or both. Exterior construction forms are usually built earlier in the process than interior construction forms. The exterior construction forms usually resemble the exterior construction forms used in pouring concrete foundations. The interior construction forms may partially resemble the metal work or lattice structures used in pouring concrete, wherein the metal work or lattice structures are encapsulated within the concrete when the concrete is poured.

The step of cutting grating materials consists of cutting grating materials to fit the particular project. The grating materials may be cut by a torch, a saw, bolt cutters, pliers, scissors, a cleaver, a splitter, a grinder, or a knife.

The step of making encapsulated panels may occur at the project site or at another location. The encapsulated panels may require 24 hours to set or cure before applying a load or force.

The step of making a grating structure includes tying, welding, forging, gluing, bolting with bolts and nuts, screwing with screws, clamping, pinning, or any fastening means to assemble a physical structure from the structural members.

The step of mixing aggregate blend can be performed by stirring the aggregate blend, tumbling the aggregate blend, or shaking the aggregate blend. The aggregate blend can be mixed by any means of mixing the aggregate blend.

The step of adding aggregate blend to grating structure can be performed by compression molding, injection molding, spraying, surface application, applying with a trowel, or pouring in place. The bonding agents and aggregate blend can be cured by waiting for the ingredients to set, adding a curing agent, or heating.

Putty, silicone, urethane, polysulfide, butyl rubber can be used as sealants between construction form segments. Expandable foam and grout can be used in some applications to fill in areas of the construction forms or voids in the construction forms.

Segmented structural members may be held together by elongated structural members that occupy orifices in the segmented structural members. The elongated structural members with fastening means may be used as clamps to clamp segmented structural members together. A pipe, tube, or encasing structure can hold the segmented structural members together. The segmented structural members can be affixed with adhesives, welding, forging, bolts and nuts, all thread and nuts, screws, pins through orifices, and clamps.

The order of performing the method steps can vary. The steps of preparing the surface area, making a construction from, and cutting grating materials can occur in different order depending upon whether a new structure is being built or a pre-existing structure is being repaired or receiving a surface overlay. The step of preparing the surface is usually the first step, provided this step is necessary for the particular situation. For building new structures, the step of making a construction form is usually one of the first two steps. If a pre-existing structure is involved, the step of making a construction form may be the third step of the method. Those skilled in the art can make appropriate choices about the order of doing the steps of the method.

The step of making a grating structure from the cut grating materials follows the step of cutting grating materials. The step of mixing the aggregate blend usually occurs after the step of making a grating structure from the grating materials. The step of adding the aggregate blend to the grating structure occurs quickly following the step of mixing the aggregate blend. The step of adding the aggregate blend to the grating structure is a time sensitive step. The step of adding the aggregate blend to the grating structure is performed quickly after the step of mixing the aggregate blend to keep the aggregate blend from hardening prior to the step of adding the aggregate blend to the grating structure. A partially hardened aggregate blend may not completely occupy the desired space of the surface overlay or structure.

The steps of making a grating structure from the cut grating materials and making a construction form usually take significant time. To prevent the possibility of the aggregate blend hardening before these steps are accomplished, these steps are usually performed prior to the step of mixing the aggregate blend. In some applications, it may be possible to change this order of steps, but normally it is unwise to do so.

The step of performing the finishing procedures is the last step of the method. The step of adding the aggregate blend to grating structure is the penultimate step of the method. The step of performing the finishing procedures usually occurs about 24 hours after the step of adding the aggregate blend to grating structure. The aggregate blend takes approximately 24 hours to fully cure. A step of applying pressure to perform a compression molding can be performed between the steps of adding the aggregate blend to grating structure and performing the finishing procedures.

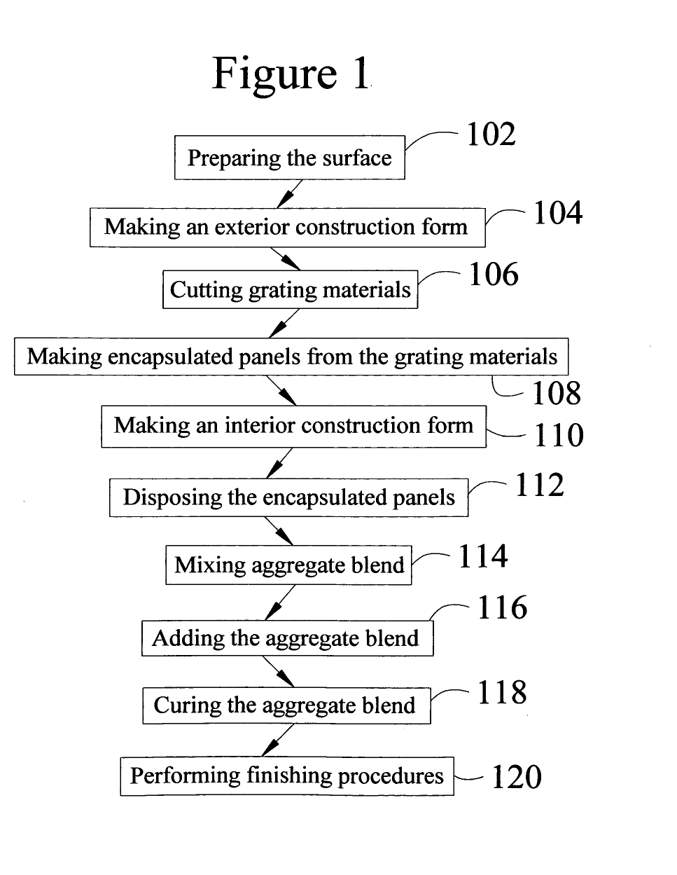

In FIG. 1, a flow diagram of a version of the method is depicted. The flow diagram in FIG. 1 depicts the order of steps when a new structure is being made. The arrows depicted in the flow diagram show the order of steps of this version of the method. Each successive arrow, from top to bottom, points to the next step of the method. Some of these steps can be omitted. The order of some steps may be altered. FIG. 1 represents a likely order of steps.

The optional step of preparing the surface 102 is usually the first step when this step is performed. The step of making an exterior construction form 104 is the first step when the optional step of preparing the surface 102 is not performed and the step of making an exterior construction form 104 is the second step when the optional step of preparing the surface 102 is performed.

The step of cutting grating materials 106 follows the step of making an exterior construction form 104. The step of making encapsulated panels from the grating materials 108 follows the step of cutting grating materials 106. The step of making an interior construction form 110 follows the step of making encapsulated panels from the grating materials 108.

The step of disposing the encapsulated panels 112 follows the step of making an interior construction form 110. The step of mixing the aggregate blend 114 follows the step of disposing the encapsulated panels 112. The step of adding the aggregate blend 116 follows the step of mixing the aggregate blend 114. The step of performing finishing procedures 120 follows the step of curing the aggregate blend 118. The step of performing finishing procedures 120 is the last step of the method.

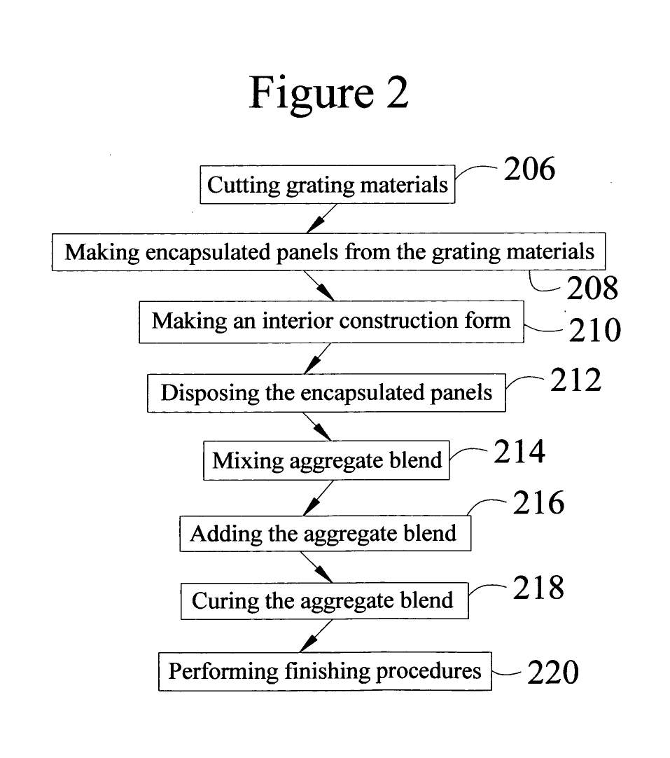

In FIG. 2, a flow diagram of a version of the method is depicted. The flow diagram depicts a likely order of steps when a pre-existing structure is being repaired or having a surface overlay being applied.

The arrows depicted in the flow diagram show the order of steps of this version of the method. Each successive arrow, from top to bottom, points to the next step of the method. Some of these steps may be omitted. The order of some steps may be altered. FIG. 2 represents a likely order of steps.

The step of cutting grating materials 206 can be the first step of the method. The grating materials are cut to desired dimensions for the particular application. The step of making encapsulated panels from the grating materials 208 follows the step of cutting grating materials 206. The resin can be applied to the grating materials to encapsulate the grating materials. When the encapsulated grating materials dry, encapsulated panels are formed. The step of making an interior construction form 210 follows the step of making encapsulated panels from the grating materials 208. There can be variation in the components and configuration of the interior construction form. The interior construction form is made to meet the requirements of the particular application. For heavy duty applications, the interior construction form is made from strong metal components that can be welded in place and the encapsulated panels are made from metal grating material. For light duty applications, the interior construction form will be made from weaker components that can be clipped into place and the encapsulated panels can be made of wire mesh or plastic grating.

The step of disposing the encapsulated panels 212 follows the step of making an interior construction form 210. The encapsulated panels are disposed in accordance with the particular application. Where heavy weights are being stored on the structure being repaired, the encapsulated panels will be made of metal grating material and the encapsulated panels will be disposed horizontally usually just below the surface of the structure. If the structure incurs heavy forces being applied from a horizontal direction on one side of the structure, the encapsulated panels will be heavy duty and the encapsulated panels will be disposed vertically on the side of the structure having the heavy forces. The step of mixing the aggregate blend 214 follows the step of disposing the encapsulated panels 212. The step of adding the aggregate blend 216 follows the step of mixing the aggregate blend 214. The aggregate blend can harden quickly after mixing. For this reason, the addition of the aggregate blend usually quickly follows the step of mixing the aggregate blend. The step of performing finishing procedures 220 follows the step of curing the aggregate blend 218. The aggregate blend takes approximately 24 hours to cure. This curing time can vary with the particular blend and the particular application. The step of performing finishing procedures 220 is the last step of the method. The finishing procedures usually involve troweling the surface, painting, and removing any exterior construction forms.

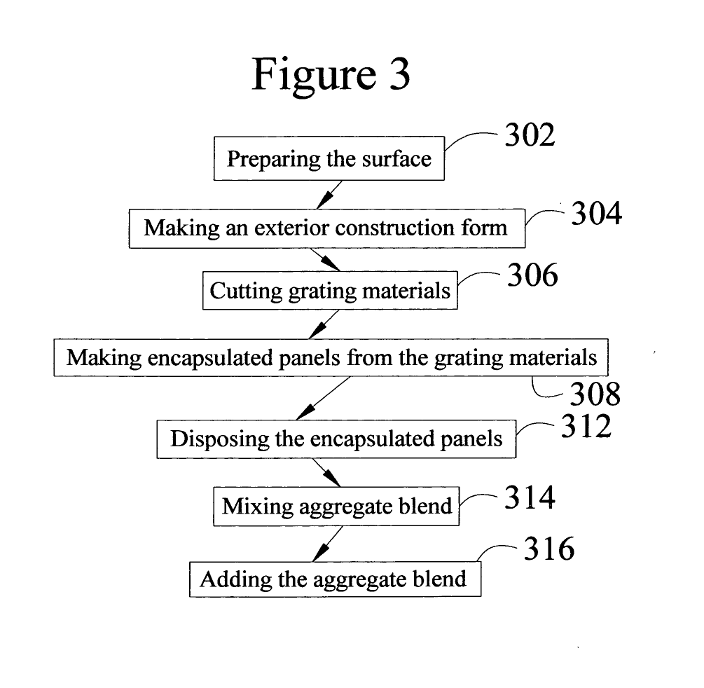

In FIG. 3, a flow diagram of a version of the method is depicted. The flow diagram depicts another likely order of steps when a pre-existing structure is being repaired or having a surface overlay being applied.

The arrows depicted in the flow diagram show the order of steps of this version of the method. Each successive arrow, from top to bottom, points to the next step of the method. Some of these steps may be omitted. The order of some steps may be altered. FIG. 3 represents a likely order of steps.

The optional step of preparing the surface 302 is usually the first step when this step is performed. The step of making an exterior construction form 304 is the first step when the optional step of preparing the surface 302 is not performed and the step of making an exterior construction form 304 is the second step when the optional step of preparing the surface 302 is performed.

The step of cutting grating materials 306 follows the step of making an exterior construction form 304. The step of making encapsulated panels from the grating materials 308 follows the step of cutting grating materials 306. The step of disposing the encapsulated panels 312 follows the step of making encapsulated panels from the grating materials 308.

The step of mixing the aggregate blend 314 follows the step of disposing the encapsulated panels 312. The step of adding the aggregate blend 316 follows the step of mixing the aggregate blend 314. The step of step of adding the aggregate blend 316 can be the last step of the method.

The structures being made by the inventive processes may be held in place by anchors, braces, and stakes. Fiberglass gratings, metal gratings, and expanded metal gratings are generally used in heavy duty applications. Plastic gratings are generally used in light duty applications. The steps of the method may be consecutively performed or may have significant time gaps between the steps. Those skilled in the art will be able to appreciate the timing of the steps, especially with the guidance contained herein.

The grating materials are usually held in a linear position prior to applying resins to make the encapsulated panels flat. The preferred way to make the panels is to apply resins, epoxy, grout, and any other ingredients to the top of the grating material first and then proceed to the bottom of the grating material. Dripping of the applied materials can be expected. Positioning a long side of the grating materials vertically can help in applying the resins, grout, or other ingredients. The preferred bonding agents for encapsulating the grating materials are resins.

A preferred way to make the grating structure is to use vertically disposed encapsulated panels with horizontal orifices, rods and bearing bars. The rods are disposed as cross rods, usually in a horizontal placement. The rods are disposed to occupy the horizontal orifices of the panels. The bearing bars are disposed vertically to bear the main burden of any weight being applied to the structure. A locking design is employed to affix the cross rods to the bearing bars. A locking design that forms a permanent connection is preferred. The applicant's horizontal orifices in their panels are one quarter to one inch in diameter. Rebar can be used as a cross rod.

The invention can be used in secondary containment of concrete structures; steel and concrete frame structures; making columns and beams; equipment foundations; acid and caustic sumps; catch basins for plant drainage and runoff; clarifier's concrete walls and floors; decking for stairs; above grade decks; below grade decks; building walls and floors; concrete basins; roofs; docks; airports; platforms; flumes; water treatment facilities; sewage basins; manholes; garage floors; blast proof walls; walls and floors for communication buildings; battery charging areas for the walls and floor; analyzer buildings walls and floor; electrical buildings walls and floors; and laboratory walls, floors, counter tops, and doors.

Those skilled in the art will recognize that the methods disclosed herein can be used to make underwater structures, repair underwater structures, waterproof underwater structures, and strengthen existing structures whether underwater or not. The segmented construction forms can be used on underwater structures.

While the invention has been described with respect to a limited number of method steps, those skilled in the art will appreciate numerous modifications and variations therefrom. It is intended that the appended claims cover all such modifications and variations as fall within the true spirit and scope of the invention.

What is claimed is:

1. A method, the method comprising:
cutting grating materials to fit the particular application,
applying a bonding agent to the grating materials to make encapsulated panels,
disposing one or more encapsulated panels, and
adding aggregate blend to the encapsulated panels to form a structure.

2. The method of claim 1, wherein the encapsulated panels are disposed very near the surface of the structure.

3. A method, the method comprising:
cutting grating materials to fit the particular application,
making one or more encapsulated panels from the grating materials, wherein the step of making the encapsulated panels from the grating materials occurs after the step of cutting grating materials to fit the particular application,
disposing the encapsulated panels,
mixing an aggregate blend, and
adding the aggregate blend to the encapsulated panels, wherein the step of adding aggregate blend to the encapsulated panels occurs after the step of mixing an aggregate blend.

4. The method of claim 3, further comprising:
making an exterior construction form to partially surround a space, wherein the step of making an exterior construction form occurs before the step of adding the aggregate blend,
disposing the encapsulated panels within the space, and
adding the aggregate blend to the encapsulated panels and the space being partially surrounded by the exterior construction form.

5. The method of claim 3, further comprising:
making an interior construction form, wherein the interior construction form occupies a space,
disposing the encapsulated panels within the space, and
adding the aggregate blend to the encapsulated panels and the space.

6. The method of claim 5, wherein the interior construction form is made of rods, the encapsulated panels have transverse orifices extending through the panels, and the rods occupy the orifices.

7. The method of claim 6, wherein the grating materials have bearing bars and the rods are affixed to the bearing bars.

8. The method of claim 5, further comprising:
bearing bars, wherein the bearing bars are incorporated into the interior construction form.

9. The method of claim 6, further comprising:
bearing bars, wherein the bearing bars are incorporated into the interior construction form and the rods are affixed to the bearing bars.

10. The method of claim 4, wherein the step of making an exterior construction form occurs before the step of mixing the aggregate blend.

11. The method of claim 5, wherein the step of making an interior construction form occurs before the step of mixing the aggregate blend.

12. The method of claim 3, further comprising:
performing finishing procedures, wherein the step of performing the finishing procedures is the last step of the method.

13. The method of claim 3, further comprising:
preparing the surface, wherein the step of preparing the surface occurs before the step of adding the aggregate blend.

14. The method of claim 13, wherein the step of preparing the surface is the first step of the method.

15. The method of claim 4, further comprising:
using compression molding to apply pressure to the aggregate blend after the aggregate blend is added.

16. The method of claim 4, wherein the exterior construction form is made of segments and the segments are assembled together to make the exterior construction form.

17. The method of claim 16, further comprising:
applying sealants between the segments of the exterior construction form.

18. The method of claim 16, further comprising:
affixing the segments of the exterior construction form together.

19. The method of claim 3, further comprising:
curing the aggregate blend after the aggregate blend is added.

20. The method of claim 19, wherein the aggregate blend is cured for approximately 24 hours.
